(19) United States
(12) Patent Application Publication
(10) Pub. No.: US 2014/0279707 A1
(43) Pub. Date: Sep. 18, 2014

(54) SYSTEM AND METHOD FOR VEHICLE DATA ANALYSIS

(71) Applicant: CAA South Central Ontario, (US)

(72) Inventors: Robin Joshua, Thornhill (CA); Oswaldo Emilio Rojas-Silva, Stouffville (CA); Christopher Stamp, Stouffville (CA)

(21) Appl. No.: 13/835,773

(22) Filed: Mar. 15, 2013

(51) Int. Cl. G06Q 30/02

(52) U.S. Cl. CPC G06Q 30/0283
USPC 705/400; 701/1; 701/29.1

(57) ABSTRACT

The described embodiments relate to systems, methods and computer readable media for determining compliance with recommendations. The systems and methods may involve generating a vehicle recommendation; transmitting the vehicle recommendation to at least one output device, wherein the at least one output device communicates the vehicle recommendation to one or more users; collecting vehicle telemetry data from a vehicle sensor device located in a vehicle, wherein the vehicle sensor device is coupled to one or more vehicle sensors; and determining compliance data based on the vehicle recommendation and the vehicle telemetry data, wherein the compliance data indicates compliance with the recommended vehicle action. The compliance data may be used to determine service rates and/or service level coverage for users.

### FIELD

The embodiments described herein relate to the field of analyzing vehicle related data, and in particular to, collecting and analyzing real-time vehicle related data.

### INTRODUCTION

Data about a vehicle may be obtained through a variety of mechanisms such as on-board diagnostics systems and devices with sensors and transceivers located within the vehicle. In addition, environmental and contextual data related to vehicles, such as speed limits, maps, traffic, weather, and so on, may also be obtained through a variety of mechanisms. There exists a need for improved methods and systems for services providers to collect and use vehicle related data, such as by generating alert notifications and determining costs, coverage, and rates for various vehicle related services, such as insurance and roadside assistance.

### SUMMARY

In a first aspect, embodiments described herein provide a computer implemented method for determining compliance with vehicle recommendations, wherein the computer comprises a processor and a memory coupled to the processor and configured to store instructions executable by the processor to perform the method comprising: generating a vehicle recommendation, wherein the vehicle recommendation comprises a recommended vehicle action; transmitting the vehicle recommendation to at least one output device, wherein at least one output device communicates the vehicle recommendation to one or more users; collecting vehicle telemetry data from a vehicle sensor device located in a vehicle, wherein the vehicle sensor device is coupled to one or more vehicle sensors; and determining compliance data based on the vehicle recommendation and the vehicle telemetry data, wherein the compliance data indicates compliance with the recommended vehicle action. In some embodiments, the method may be implemented as a system and computer readable medium for determining compliance with vehicle recommendations.

In some embodiments, the output device is located in the same vehicle as the vehicle sensor device. In some embodiments, the recommendation is generated using environmental data relating to the vehicle that the vehicle sensor device is located in.

In some embodiments, generating the vehicle recommendation further comprises: gathering vehicle telemetry data from other vehicles; and generating the vehicle recommendation based on the vehicle telemetry data gathered from other vehicles.

In some embodiments, generating the vehicle recommendation further comprises comparing the telemetry data from the other vehicles to one or more vehicle conditions to select the recommended vehicle action. In some embodiments, generating the vehicle recommendation further comprises: gathering vehicle telemetry data from the vehicle sensor device; and generating the vehicle recommendation based on the vehicle telemetry data gathered from the vehicle sensor device.

In some embodiments, the method may further comprise: storing a profile linked to the vehicle sensor device; and recording a compliance metric in the profile, wherein the compliance metric is based on the compliance data.

In some embodiments, the method may further comprise: recording a recommendation metric in the profile based on the vehicle recommendation.

In some embodiments, the compliance metric is for use in determining a service rate for providing one or more vehicle services. In some embodiments, the method may further comprise: determining the service rate, wherein the service rate is determined based on the compliance metric.

In some embodiments, the compliance metric is for use in determining a service level defining coverage of one or more vehicle services. In some embodiments, the method may further comprise: determining the service level, wherein the service level is determined based on the compliance metric.

In some embodiments, the vehicle telemetry data is selected from the group consisting of: a condition of the vehicle, a manner of operating the vehicle, and a condition of an environment for the vehicle.

In some embodiments, vehicle telemetry data gathered from the other vehicles comprises a plurality of data sets, each data set being associated with an identifier corresponding to a vehicle selected from the other vehicles that the vehicle telemetry data was gathered from, a timestamp, and a location.

In some embodiments, the vehicle telemetry data comprises vehicle diagnostic data, and wherein at least one vehicle sensor device is coupled to an onboard diagnostic system of the vehicle.

In some embodiments, the vehicle condition relates to one or more members selected from the group consisting of: a condition of a vehicle, manner of operating a vehicle, and a condition of an environment for a vehicle.

In some embodiments, the recommended vehicle action relates to one or more members selected from the group consisting of: a condition of a vehicle, manner of operating a vehicle, and a condition of an environment for a vehicle.

In some embodiments, the recommended vehicle action refers to a location defined by a geographical tag proximate to the vehicle.

In some embodiments, the vehicle telemetry data gathered from the other vehicles comprises a plurality of data sets, each data set associated with a timestamp and a location, and wherein generating the vehicle recommendations further comprises: correlating the data sets based on the timestamps and the locations.

In some embodiments, the output device is operable to display the recommended vehicle action. In some embodiments, the output device is located within the same vehicle as the vehicle sensor device. In some embodiments, the output device and the vehicle sensor device form are integrated as part of the same device. In some embodiments, the output device comprises an electronic sign observable by the vehicle. In some embodiments, the output device is located in the same vehicle as the vehicle sensor device and generates audible output corresponding to the recommended vehicle action.

In another aspect, embodiments described herein provide a computer implemented method for determining compliance with vehicle recommendations, wherein the computer comprises a processor and a memory coupled to the processor and configured to store instructions executable by the processor to perform the method comprising: gathering vehicle telemetry data from a vehicle sensor device located in a vehicle, wherein the vehicle sensor device is coupled to one or more vehicle sensors; generating a vehicle recommendation, wherein the vehicle recommendation comprises a recommended vehicle action; transmitting a report to at least one output device, wherein the report comprises the vehicle recommendation; collecting additional vehicle telemetry data from the vehicle sensor device located in the vehicle; and determining compliance data based on the vehicle recommendation and the additional vehicle telemetry data, wherein the compliance data indicates compliance with the recommended vehicle action.

In some embodiments, the method may further comprise determining a service rate for providing one or more vehicle services, wherein the service rate is determined based on the compliance data.

In some embodiments, the method may further comprise determining a service level defining coverage of one or more vehicle services, wherein the service level is determined based on the compliance data.

In some embodiments, the vehicle telemetry data is selected from the group consisting of: a condition of the vehicle, a manner of operating the vehicle, and a condition of an environment for the vehicle.

In another aspect, embodiments described herein may provide a computer implemented method for collecting vehicle data from devices located in vehicles, wherein the computer comprises a processor and a memory coupled to the processor and configured to store instructions executable by the processor to perform the method comprising: storing a plurality of user profiles for a corresponding plurality of users, wherein each user profile comprises a user identifier corresponding to a user, selected from the plurality of users and a plurality of metrics; transmitting a notification to at least one device when a vehicle condition is met by collected data sets, wherein at least one device is associated with a user identifier corresponding to a user selected from the plurality of users, wherein the notification comprises a recommended vehicle action; collecting telemetry data used to determine compliance data, wherein the compliance data indicates compliance with the recommended vehicle action; and recording an additional metric in the profile comprising the user identifier associated with at least one device, wherein the additional metric is based on the compliance data.

In accordance with some embodiments, at least one device is located in a vehicle. In accordance with some embodiments, the telemetry data for determining the compliance data is collected from at least one device. In accordance with some embodiments, at least one device receives the data used to determine compliance from one or more sensors located in the vehicle.

In accordance with some embodiments, the method may further comprise generating the notification by selecting the recommended vehicle action based on the vehicle condition. In accordance with some embodiments, the method may further comprise recording a metric based on the notification in the profile comprising the user identifier associated with at least one device.

In accordance with some embodiments, the plurality of metrics of each user profile are for use in determining a service rate for providing one or more vehicle services to the respective user.

In accordance with some embodiments, the method may further comprise determining the service rate, wherein the service rate is determined based on the additional metric.

In accordance with some embodiments, the plurality of metrics of each user profile are for use in determining a service level defining coverage of one or more vehicle services for the respective user.

In accordance with some embodiments, the method may further comprise determining the service level, wherein the service level is determined based on the additional metric.

In accordance with some embodiments, the plurality of metrics of each user profile comprise one or more members selected from the group consisting of: a condition of a vehicle, a manner of driving a vehicle, and a condition of an environment for a vehicle.

In accordance with some embodiments, the method may further comprise collecting the data sets, wherein at least a portion of the data sets are collected from one or more devices located in one or more vehicles, wherein each of the one or more devices is associated with a user identifier corresponding to a user selected from the plurality of users.

In accordance with some embodiments, each data set comprises a user identifier corresponding to the device the data set was received from, a timestamp, and a location identifier.

In accordance with some embodiments, the collected data sets comprise telemetry vehicle data, and wherein the at least one device receives the vehicle data from one or more sensors located in the vehicle.

In accordance with some embodiments, the collected data sets comprise vehicle diagnostic data, and wherein at least one device receives the vehicle diagnostic data from an onboard diagnostic system of the vehicle.

In accordance with some embodiments, the vehicle condition relates to one or more members selected from the group consisting of: a condition of a vehicle, manner of driving a vehicle, and a condition of an environment for a vehicle.

In accordance with some embodiments, the recommended vehicle action relates to one or more members selected from the group consisting of: a condition of a vehicle, manner of driving a vehicle, and a condition of an environment for a vehicle.

In accordance with some embodiments, the vehicle condition is defined by a geographical tag of a location made by a user of the plurality of users and wherein at least a portion of the collected data sets comprises a location identifier corresponding to the location of the geographical tag.

In accordance with some embodiments, the method may further comprise collecting the data sets from each of a plurality of devices located in a corresponding plurality of vehicles, wherein each device is associated with a user identifier corresponding to a user selected from the plurality of users, and wherein each data set comprises a user identifier corresponding to the device the vehicle data set was received from, a timestamp, and a location identifier; and correlating the data sets based on at least one of the user identifiers, the timestamp and the location identifier; wherein the notification is transmitted when a vehicle condition is met by the correlated vehicle data sets.

In another aspect, embodiments described herein may provide a computer implemented method for collecting vehicle data from devices located in vehicles, wherein the computer comprises a processor and a memory coupled to the processor and configured to store instructions executable by the processor to perform the method comprising: storing a plurality of user profiles for a plurality of users, wherein each user profile comprises a user identifier corresponding to a user selected from the plurality of users; collecting data sets from each of a plurality of devices located in a corresponding plurality of vehicles, wherein each device is associated with a user identifier corresponding to a user selected from the plurality of users, wherein each vehicle data set comprises a user identifier corresponding to the device the vehicle data set was received from, a timestamp, and a location identifier; correlating the vehicle data sets based on at least one of the user identifiers, the timestamp and the location identifier; transmitting a notification to at least one device selected from the plurality of devices when a vehicle condition is met by the vehicle data sets, wherein the vehicle condition corresponds to a user identifier, wherein at least one device corresponds to the user identifier, and wherein the notification comprises a recommended vehicle action; and recording an additional metric in the profile comprising the user identifier associated with at least one device, wherein the additional metric is based on the vehicle condition and the recommended vehicle action.

In accordance with some embodiments, the method may further comprise determining a service rate for providing one or more vehicle services to the respective user, wherein the service rate is determined based on the additional metric.

In accordance with some embodiments, the method may further comprise gathering telemetry data used to determine compliance data from the device the notification was transmitted to, wherein the compliance data indicates compliance with the recommended vehicle action; recording a compliance metric in the profile comprising the user identifier associated with the at least one device, wherein the compliance metric is based on the compliance data.

In accordance with some embodiments, the method may further comprise determining a service rate for providing one or more vehicle services to the respective user, wherein the service rate is determined based on the compliance metric.

In a further aspect, embodiments described herein may provide a system for collecting vehicle data from devices located in vehicles comprising a processor and a memory coupled to the processor and configured to store instructions executable by the processor to: store a plurality of user profiles for a corresponding plurality of users, wherein each user profile comprises a user identifier corresponding to a user selected from the plurality of users and a plurality of metrics; transmits a notification to at least one device when a vehicle condition is met by collected telemetry data, wherein the at least one device is associated with a user identifier corresponding to a user selected from the plurality of users, wherein the notification comprises a recommended vehicle action; collect telemetry data used to determine compliance; collects compliance data, wherein the compliance data indicates compliance with the recommended vehicle action; and records an additional metric in the profile comprising the user identifier associated with at least one device, wherein the additional metric is based on the compliance data.

In another aspect, embodiments described herein may provide a computer readable storage medium storing one or more sequences of instructions, which when executed by one or more processors, causes one or more processors to perform a method for collecting vehicle data from devices located in vehicles comprising: storing a plurality of user profiles for a corresponding plurality of users, wherein each user profile comprises a user identifier corresponding to a user selected from the plurality of users and a plurality of metrics; transmitting a notification to at least one device when a vehicle condition is met by collected telemetry data, wherein at least one device is associated with a user identifier corresponding to a user selected from the plurality of users, wherein the notification comprises a recommended vehicle action; collecting telemetry data used to determine compliance data, wherein the compliance data indicates compliance with the recommended vehicle action; and recording an additional metric in the profile comprising the user identifier associated with at least one device, wherein the additional metric is based on the compliance data.

Other aspects and features will become apparent, to those ordinarily skilled in the art, upon reviewing of the following description of some exemplary embodiments.

### DRAWINGS

FIG. 1 is a block diagram of a system for collecting and analyzing vehicle data to determine compliance with one or more vehicle recommendations according to one or more embodiments;

FIG. 2 is a block diagram of a central server system for collecting and analyzing vehicle data to determine compliance with one or more vehicle recommendations according to one or more embodiments;

FIG. 3 is a block diagram of a client device for collecting vehicle telemetry data and receiving vehicle recommendations and according to one or more embodiments;

FIG. 4 is a flow chart diagram of a method for collecting and analyzing data to determine compliance with one or more vehicle recommendations according to one or more embodiments;

FIG. 5 is a schematic diagram a variety of vehicle related services; and

FIG. 6 is another schematic diagram a variety of vehicle related services.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions may also be in various forms, including compiled and non-compiled code.

Referring now to FIG. 1, there is shown a block diagram of a system 10 for collecting and analyzing vehicle data according to some embodiments. System 10 may be operable to collect real-time data from a variety of sources, such as onboard devices 14 located in vehicles 12, store the collected vehicle data in user profiles and/or vehicle profiles at a central server 16, analyze and correlate the collected vehicle data to compute metrics and detect vehicle events, transmit near real-time alerts or notifications to devices 14 for the detected vehicle events, collect additional data in relation to the real-time notifications, compute metrics relating to compliance with the notifications, and store the computed metrics and notifications in user profiles and/or vehicle profiles at a central server 16. The alerts or notifications may include a recommended vehicle action (e.g. slow down a particular speed, service engine within a particular time) and system 10 can be further operable to collect telemetry data used to determine compliance data based on compliance with the alert or notifications and to use the compliance data as additional metrics for user profiles or vehicle profiles. The metrics may be used to compute service rates or service coverage for various vehicle related services such as insurance, roadside assistance, membership for a vehicle service organization, and so on.

Through sending alerts or notifications with recommended vehicle actions, system 10 may reduce accidents on the road, prevent vehicle failure, advocate for safer driving conditions, provide alerts for unsafe driving conditions, provide ecological and environmental information and solutions, and positively influence driving behavior. Further, system 10 may collect and analyze vehicle data to improve process efficiencies within an organization and provide a real-time information exchange environment.

System 10 may provide an integrated approach to address safety, security, and service costs tailored to individual users. Specific features of system 10 can include: a real-time connection to vehicles 12 via onboard devices 14, vehicle 12 interaction via onboard devices 14, personalized web portal for users 18 to review reports and configure preferences, mobile applications for onboard devices 14, data collection from vehicles 12 via onboard devices 14, remote vehicle 14 diagnostics, safety via notifications with recommended vehicle actions, monitoring compliance with recommended actions, security via vehicle 12 monitoring, data management and analysis to detect vehicle 12 conditions for notification, road side assistance through provision of vehicle 12 related services, travel medical insurance, and usage based insurance based on data collection and analysis.

The system 10 may include a central server 16 connected to onboard devices 14a, 14b, 14c located in vehicles 12a, 12b, 12c via a network 20. The onboard device 14 may function as an output device to communicate recommendations to user 18 within vehicle 12. The onboard device 14 may function as a vehicle sensor device and may couple with sensors within vehicle 12. Central server 16 may also connect to additional data source servers 22 managing vehicle and driving related data, such as environment, weather, traffic, speed limits, road maps, and news data sources, for example. Central server 16 may provide a back end server gateway, consumer web site interface, device management tools, mobile application interface and data analysis. The collected data can be used to drive business operations and improve member relationships as they pertain to the automotive market. The additional data source servers 22 may provide syndicated data, such as data feeds, to central server 16, for example.

Central server 16 may be implemented using a server and data storage devices configured with database(s) or file system(s), or using multiple servers or groups of servers distributed over a wide geographic area and connected via a network 20. Central server 16 may reside on any networked computing device including a processor and memory, such as an electronic reading device, a personal computer, workstation, server, portable computer, mobile device, personal digital assistant, laptop, tablet, smart phone, WAP phone, an interactive television, video display terminals, gaming consoles, and portable electronic devices or a combination of these. Central server 16 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Central server 16 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Central server 16 may include one or more input devices, such as a keyboard, mouse, camera, touch screen and a microphone, and may also include one or more output devices such as a display screen and a speaker. Central server 16 has a network interface in order to communicate with other components, to serve web pages, and perform other computing applications by connecting to network 20 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one central server 16 is shown for clarity, there may be multiple central servers 16 or groups of central servers 16 distributed over a wide geographic area and connected via e.g. network 20. Further details of central server 16 will be described in relation to FIG. 2.

Onboard devices 14 may be specialized built-in devices within the vehicle 12 or may be plug-in devices to a vehicle 12. For example, an onboard device 14b may be a specialized device operable to integrate and interface with on-board diagnostics systems, and other devices and sensors located within a vehicle 14b. An onboard device 14a may also be a smart phone located in the vehicle 12a, or the onboard device 14c may be a combination of a specialized device connected to a smartphone located in a vehicle 14c. Other onboard devices 14 that can collect data relating to a vehicle, directly or indirectly, may also be used. Generally, onboard devices 14 can be any suitable device (or combination of devices) for collecting and transmitting data relating to a vehicle 12. Onboard device 14 is operable by a user 18 and may be any networked (wired or wireless) computing device including a processor and memory, such as a personal computer, workstation, server, portable computer, mobile device, personal digital assistant, laptop, smart phone, WAP phone, interactive television, video display terminals, gaming consoles, an electronic reading device, tablet, terminal, and portable electronic devices or a combination of these. Although only three onboard devices 14a, 14b, 14c are illustrated in FIG. 1, there may be more onboard devices 14 connected via network 20. Onboard device 14 may be configured with a mobile application installed or running on the onboard device 14, which may be a computing application, application plug-in, a widget, instant messaging application, mobile device application, e-mail application, online telephony application, java application, web page, or web object residing, executing, running or rendered on the onboard device 14 in order to access the functionality of central server 16, by providing and receiving data and carrying out actions and instructions, for example. Onboard device 14 is operable by a user to, for example, submit data relating to the vehicle 12, interface with other devices associated with the vehicle 12 (e.g. onboard diagnostic systems, telematics devices, and sensors located in a vehicle 12), provide input data, receive notifications, configure the central server 16 with user preferences, display visualizations of data received from central server 16, provide speech notifications based on notification data received from central server 16, provide audible notifications based on notification data received from central server 16, access data maintained by central server 16 or onboard device 14, and other functionality. Onboard device 14 is operable to register and authenticate users (using a login, unique identifier, and password for example) prior to providing access to central server 16. Onboard device 14 may be different types of devices and may serve one user or multiple users. Onboard device 14 may be connected to the central server 16 via any suitable communications channel. Onboard device 14 may also have additional embedded components such as a global positioning system (GPS), a clock, a calendar, sensors, transceivers, input/output, and so on. Onboard device 14 may also be connected to and receive data from other devices that collect data relating to the vehicle. For example, onboard device 14 may include or be connected to a navigation system, electronic mapping tool, satellite device, a diagnostic tool, tracking devices, radio device, receiver/transmitter/modem and other vehicle telematics devices. For example, a vehicle telematics device is a way of monitoring the location, movements, status, components and behavior of a vehicle. Further details of onboard device 14 will be described in relation to FIG. 3.

Network 20 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, digital radio, mobile, wireless (e.g. Wi-Fi, WiMAX), SS7 signaling network, fixed line, personal area network, local area network, wide area network, and others, including any combination of these. Although not shown, central server 16, onboard device 14, additional data source servers 22, and other components (not shown) may connect to network 20 via a firewall, which is a device, set of devices or software that inspects network traffic passing through it, and denies or permits passage based on a set of rules and other criteria. Firewall may be adapted to permit, deny, encrypt, decrypt, or proxy all computer traffic between network 20, central server 16, onboard device 14, additional data source servers 22, and other components based upon a set of rules and other criteria. For example, firewall may be a network layer firewall, an application layer firewall, a proxy server, or a firewall with network address translation functionality. Network 24 is operable to secure data transmissions using encryption and decryption.

System 10 may further include one or more computing devices 24 operable by a user 18 (or other user 26 such as an administrative user or service provider) to interface with central server 16, onboard devices 14, and other components of system 10. For example, notifications and recommendations may be sent from central server 16 to computing device 24. Computing devices 24 may function as an output device to communicate recommendations to user 18. Computing device 24 may be any networked (wired or wireless) computing device including a processor and memory, such as a personal computer, workstation, server, portable computer, mobile device, personal digital assistant, laptop, smart phone, WAP phone, interactive television, video display terminals, gaming consoles, an electronic reading device, tablet, terminal, and portable electronic devices or a combination of these. Computing device 24 may be configured with an application installed on or running on the computing device 24, which may be a computing application, application plug-in, a widget, instant messaging application, mobile device application, e-mail application, online telephony application, Java application, web page, or web object residing, executing, running or rendered on the computing device 24 in order to access central server 16, onboard devices 14, or other components of system 10. For example, computing device 24 may use an application to provide and receive data, to carry out actions and instructions, and to configure components of system 10.

The system 10 may collect vehicle related data to integrate a variety of services for provision to users 18. For example, system 10 may be used to implement usage based insurance, which may also be referred to as pay as you drive (PAYD) or pay how you drive (PHYD). Usage based insurance provides auto insurance rates based on driving time, distance, location, behavior, and other factors. System 10 is operable to manage user profiles storing computed metrics about specific users or vehicle profiles storing computed metrics about specific vehicles. The metrics are computed using collected vehicle related data. System 10 is operable to calculate insurance rates using metrics stored in the user profile or vehicle profile. For example, the metrics may indicate how often a user 18 speeds or exceeds existing speed limit, how many accidents the user 18 has been in, how fast the user 18 drives compared to other users 18 in similar driving conditions and locations, how often the user 18 services their vehicle 12, and so on. The insurance may be specific to a vehicle 12 or to a user 18. The insurance rate or coverage may vary based on compliance with recommended vehicle actions provided by notifications.

As another example, system 10 may be used for vehicle diagnostics. For example, system 10 may collect vehicle diagnostic data from onboard devices 14, such as vehicle diagnostic trouble codes (DTC) using the telematics. System 10 may provide users 18 and onboard devices 14 with proactive and reactive notifications about potential problems with vehicles 12 that may be delivered through web portal to computing device 24 or real-time notifications to onboard devices 14, which may be used to lower or save on repair costs. The notifications may include recommended vehicle actions, and telemetry data used to determine compliance data indicating compliance with the recommended vehicle actions may be collected by system 10.

As a further example, system 10 may implement a connected vehicle 12 model by leveraging both the onboard network 20 connection delivered through the onboard devices 14, and the vehicle data they collect. System 10 may include a suite of mobile applications that reside on the onboard device 14 which enable the user 18 to interact with their vehicle 12, components of system 10, and the surrounding environment.

System 10 may implement a variety of vehicle safety features. For example, using location sensors (such as a global positioning system), collected road condition data, and historical and current geographic location data, system 10 may analyze collected data to make inferences on road conditions and provide notifications to the onboard devices 14 of local road conditions, including recommended vehicle actions. System 10 may also collect data on the location of emergency vehicles and provide notification to an onboard device 14 when an emergency vehicle is on the side of the road ahead of the vehicle 12. The notifications may be delivered as text, speech, visual, and so on. System 10 may detect when user 18 enters vehicle 12 and disable text or activate voice notifications, or enable text to speech functions.

System 10 may also be used to generate geographical virtual fencing to set boundaries for vehicle 12. For example, a parent may want to set geographic boundaries around defined areas when their children are using the vehicle 12. System 10 may collect data from device 14 regarding the location of the vehicle 12, and provide notifications to the onboard device 14 or other device (e.g. device operated by parent) when the vehicle 12 leaves or is about to leave the defined area. As another example, a parent may configure system 10 to set curfew times for vehicle use 12, and speed thresholds. System 10 will collect data from onboard device 14 to detect violations and provide notifications in response. System 10 is operable to provide a notification to the onboard device 14 or to computing device 24 when the vehicle 12 leaves the set boundary and recommend that the vehicle 12 should return within the boundary. System 10 is operable to monitor compliance with the recommended action.

System 10 may collect data from onboard device 14 and determine that an accident with the vehicle 12 has occurred. System 10 may send a notification to the onboard device 14 indicating that an accident was detected and may dispatch emergency assistance. The notification may include a recommended vehicle action, and telemetry data used to determine compliance data may be subsequently gathered to determine compliance with the recommended vehicle action.

System 10 is operable to positively influence driving behavior. For example, system 10 is operable to analyze collected vehicle data to predict the occurrence of a vehicle related incident. Upon detecting that a vehicle related incident is likely to occur, system 10 is operable to transmit an alert or notification to the device 14 located within the vehicle 12, where the notification may indicate the vehicle related incident and a recommended action that may prevent the vehicle related incident. For example, the collected data may indicate that a serpentine belt needs replacement and the notification may recommend that the serpentine belt needs replacement, along with recommendations for a repair service provider proximate to the location of the vehicle 14, a home of the user 18, or a workplace of the user 18. Further, system 10 is operable to provide an interface with the repair service provider to schedule an appointment for the repair job upon receiving confirmation from the device 14. System 10 is further operable to collect data from the device 14 regarding compliance with the recommendation. For example, the user 18 may ignore the recommendation and the vehicle 14 may subsequently break down. System 10 may integrate with a service provider, such as roadside assistance provider, and the user 18 may be a member of the roadside assistance provider. The service rate the user 18 is charged or coverage the user 18 is provided may depend on the compliance data. For example, if the user 18 regularly complies with recommendations then they may be charged a lower membership rate or provided broader coverage than a user 18 who does not comply with recommendations. For this illustrative example, if the user 18 ignores recommendations to replace the serpentine belt and drives their vehicle 12 until it breaks down, then this may influence his membership rate as he may be more likely to call for a tow service which may eventually result in a higher cost for the service provider, which in turn may result in a higher membership rate for the user 18.

System 10 may collect data related to vehicle 12 from device 14 to determine vehicle health (e.g. remote diagnostics) and transmits proactive alerts or notifications to device 14 to influence safe driving behavior. For example, the system 10 may collect data from device 14 regarding the state of various vehicle 14 components and may transmit maintenance alerts or notifications in attempt to prevent unexpected vehicle 14 failures. Further, system 10 is operable to remotely control mechanical and electrical systems within vehicle 12, such as locks and lights, for example. System 10 is operable to remotely unlock doors to avoid a service vehicle dispatch to open doors. System 10 may be used to assist a service provider which may save money as they will not have to send out service vehicles every time a member locks their keys in their vehicle 12. The service provider may have an application residing on device 14 with a link to a remote mechanical control to alert system 10 about incident. Further, system 10 may collect data from device 14 to determine fault assessment if the vehicle 12 is in an accident, for example. The device 14 may interface with an onboard diagnostic system or port of the vehicle 12 to collect data about the vehicle 12 such as the mileage, speed, tires, lane drifting, route, etc. The device 14 may also interface with different sensors connected to vehicle 12 to collect data regarding acceleration, braking, etc. The data may be analyzed to determine the context and environment for the accident to assess fault. The data may also be correlated with data relating to other vehicles 12 involved in the accident or proximate to the location of the vehicle 12, for example.

As another example, system 10 may analyze data collected from vehicle 14 to detect a failure with the vehicle 12 and may automatically dispatch a service vehicle. The collected data may be remote diagnostic data about the vehicle 12 and a location of the vehicle 14, for example. A notification may be sent to device 14 to indicate that a service vehicle has been dispatched.

As a further example, system 10 is operable to include a database of geographical referencing or mapping for various service providers to send recommendations of service providers to onboard device 14 when an incident with vehicle 12 is detected, such as a likely failure or accident. The location of the vehicle 12 may be collected from onboard device 14 and used to identify appropriate service providers in close proximity to the vehicle 12.

As an additional example, system 10 may be used to advocate for environment conscious behavior. System 10 may process the collected data and generate a report about current state and recommendations for fuel conservation and emissions control. System 10 is operable to collect telemetry data used to determine compliance data regarding compliance with the recommended actions. For example, the recommendations may include suggested shortest routes based on historical location information (e.g. route between home and workplace), traffic information, vehicle health, and so on. System 10 may also monitor, via various onboard sensors and onboard diagnostic systems connected to device 14, the approximate or exact type(s) of the gasoline or fuel in a vehicle's 12 gas tank. For example, a vehicle 12 designed to operate on premium 91 octane gasoline may still run on the lower 87 octane gasoline, however, it may not be operating at the most efficient condition with 87 octane gasoline. Occasionally users 18 may also use a mixture of different types of gasoline or fuel for vehicle 12. System 10 can detect the type(s) of gasoline or fuel in vehicle's 12 gas tank and alerts user 18 when it detects that the gasoline or fuel in the gas tank is not the best type of gasoline or fuel for vehicle 12. In addition, system 10 may also learn, from an internal or external database, the most environmentally friendly gasoline or fuel type for vehicle 12 and notifies user 18 accordingly. The notification may prompt user 18 to switch to a more environmentally friendly gasoline or fuel type. System 10 is operable to collect data regarding the condition of the vehicle 12 (such as for example, exhaust, fuel consumption, tire pressure, service, maintenance, fuel type, engine type) and generate environmental recommendations based in the condition of the vehicle 12. System 10 is operable to collect data regarding the driving behavior of the user 18 in the vehicle 12 (such as for example, speed, idling) and generate environmental recommendations based in the driving behavior. System 10 is operable to collect data regarding the environmental and context of the user 18 and the vehicle 12 (such as for example, traffic level, weather) and generate environmental recommendations based in the driving behavior. System 10 is operable to calculate an environmental score for the user 18 or vehicle 12, which may be recorded as a metric in the user profile or vehicle profile for reporting, calculating service rate, calculating service coverage, and so on.

As a further example, system 10 is operable to interact with device 14 to collect data and send notifications for vehicle 12 anti-theft deterrents. Device 14 may detect that break-in attempts are made and may send a sound notification or trigger an alarm to deter theft. Further, system 10 may receive notification that vehicle 12 is stolen and may track location of vehicle 12 through device 14. System 10 may be further operable to slow or stop the stolen vehicle 12 down if system 10 detects that vehicle 12 is in a safe environment in which it can be slowed down or stopped without affecting road traffic or safety.

As another example, system 10 may implement usage-based and behavior based pricing for offerings by service providers, such as roadside assistance and insurance. System 10 may influence driving behavior which may in turn reduce costs for service provider relating to roadside assistance and insurance. These reduced costs may be passed onto user 18 by way of reduced rates. System 10 may transmit accident alerts, vehicle 12 theft alerts, assist vehicle 12 recoveries, assist in determining the cause of automotive accidents, and so on. System 10 is operable to generate a report of collected data for user 18 to encourage transparent ratings and enable the user 18 to see how their rates are determined. This may allow member users 18 to control of their premium and rate based on their behavior, thereby encouraging safer driving through the incentive of a reduced rate.

Referring now to FIG. 2 there is shown central server 16 in further detail. Central server 16 has a processor and data storage device storing instructions, the instructions being executable to configure the processor to provide a number of functional modules including: an interface module 32, profile module 34, data aggregator module 36, cost calculation module 38, condition module 40, data storage module 42, notification module 44, and compliance module 46, for example. Central server 16 is operable to implement fewer or additional modules. A communication bus (not shown) enables asynchronous communication and data exchange between the central server 16 components. The components of the central server 16 are modular and can function independently or together.

Central server 16 is operable to receive input from multiple data sources 30 such as multiple onboard devices 14, government or third party traffic data sources, environment data sources, and other data sources. For example, onboard devices 14 may interact with a variety of sensors, onboard diagnostic systems, and so on, to collect data regarding a particular vehicle. Central server 16 is operable to receive input data relating to vehicles and surrounding environment from multiple data sources 30 such as traffic sensors, radio data feeds, web data feeds, human supplied observations, maintenance and construction systems, weather systems, emergency systems (e.g. accident reports), environmental sensors, event databases, mapping databases, speed limit databases, school zone databases, and so on. The data may be collected from data sources 30 in real-time or near real-time. The data may be filtered before it is provided to central server 16, or it may be provided as raw data and filtered by central server 16.

Central server 16 may be further operable to receive real-time (or near real-time) data from other data sources such as an external database storing information regarding abnormal or dangerous driving zones. Such information can be updated in real-time by users of the road including drivers, commuters and pedestrians. The information may pertain to unsafe road condition or intersection, hidden stop sign, construction zone, accident zone and so on. The information may be uploaded to the external database by users of the road via system 10, other vehicle communication systems, device 14, computing device 24, a mobile phone connected to a network, or simply by calling a third party vendor who maintains the database. Depending on where vehicle 12 is located, central server 16 may obtain relevant information from the external database. For example, upon user 18 and vehicle 12 entering a regional highway, central server 16 may inquire and receive, via interface module 32, road condition information from the external database. The received information may indicate that there is reported tire debris on the highway two kilometers ahead of vehicle 12, and central server 16 may via interface module 32 operate onboard device 14 to notify user 18 appropriately and may further advise user 18 to take an alternative route. The data sources may provide indications of vehicle condition and driving behavior. For example, vehicle maintenance or condition may be based on faults, warning lights (e.g. is a light on, how long is light on, when did light go off), tire pressure, and other diagnostic data. Driving behavior may be based on mileage, speed, braking, accelerations, compliance with rules of road (e.g. seatbelt usage), time, location, gyroscope, steering, lane changing (e.g. tail gating car that constantly changes lane, dangerous driving, distance to vehicle 12 in front, lane sensors, cameras in mirrors of vehicle 12, and so on. Contextual and environmental factors may include location, school zones, speed limits, weather, traffic, government data on road conditions, active data entries from drivers and service providers (geographical tagging re unsafe intersection, hidden stop signs, construction, etc.), and so on. Interface module 32 is operable to interface with onboard device 14 and other data sources 30 in order to collect vehicle related data for storage and processing. Interface module 32 is operable to route data to data storage module 42 for storage, to data aggregator module 36 for processing, and route requests and corresponding data to appropriate modules for processing. Interface module 32 is further operable to interface with an application on onboard device 14 in order to transmit notifications and receive telemetry data regarding compliance with recommendations.

Profile module 34 is operable to manage user or vehicle profiles for users and service provider profiles for service providers (used for recommending providers, service rates, receiving reports for its users, and so on). A profile may include a number of computed metrics, data entries, or data records. For example, a user profile may contain raw or processed data regarding a vehicle 12 received from an onboard device 14 associated with the respective user 18 such as route, speed traveled, distance traveled, time, date, location, destination, issues with vehicle, and so on. User profile may also include information regarding a user, such as a username (or other user identifiers), password(s), home address, work address, phone number, vehicle information, preference information (such as preferred service providers), and no on. The user profile may also record data entries about notifications sent to onboard device 14 associated with the user. The notifications may include recommended vehicle actions, and the user profile may also record data entries about compliance with the recommended vehicle actions. The metrics and data entries may be used by cost calculation module 38 to determine a service rate for the user. For example, the telemetry data used to determine the compliance data may be factored in to determine an insurance rate for the user or a periodic rate for providing roadside assistance (e.g. towing of vehicle 12) for the user. In a similar manner, a vehicle profile may also be created and managed by profile module 34 for each vehicle associated with one or more users. That is, a vehicle profile of vehicle 12 can be linked to one or more user profiles, with each user profile corresponding to a driver of vehicle 12. A vehicle profile may include a vehicle identifier, one or more user identifiers, and so on. A vehicle may have multiple drivers and thus a vehicle profile may be linked to multiple user profiles. The vehicle profile may include raw or processed data regarding vehicle 12, and such data may overlap with those included in the user profile. The vehicle profile may include further data fields such as service or maintenance history, mileage amount and history, brand, model and make of the vehicle, active error/fault/trouble code(s) in the onboard diagnostic system, location of parking garage(s), associated drivers or users, and so on.

Service rate or service coverage may be charged per person, per vehicle, per certain amount of road or mileage coverage, or based on any combinations thereof. The metrics that may be considered in calculating a service rate or service coverage can include vehicle record, personal driving history, individual characteristics, and compliance data, all of which are described in detail herein. The metrics may also include data from the abovementioned user profile or vehicle profile where appropriate.

Vehicle record can include service or maintenance history, mileage amount and history, brand, model and make of the vehicle, active error/fault/trouble code(s) in the onboard diagnostic system, location of parking garage(s), GPS history, most current detectable location, and so on. For example, GPS history may relate to where the vehicle 12 has been in the past X months, and where it is located at any given moment.

Personal driving history can include traffic tickets, at-fault accidents, no-fault accidents, parking tickets, most commonly drive route(s), driving habits, driving records, and so on.

Individual characteristics can include if a user is sleep deprived, a drug addict, a substance abuser, criminal records, age, weight, height, educational background, physical or mental disability, and so on.

Compliance data can include processed telemetry data indicating compliance with the recommended vehicle action provided. As will be described in greater detail herein, compliance module 46 is operable to collect telemetry data and process the telemetry data used to determine compliance data for the recommended action. Metrics related to the compliance data may be stored in user or vehicle profile and used to calculate service rates or service coverage for users or vehicles. For example, a recommendation may be to service an engine in a particular amount of time. Compliance data may indicate whether or not the engine was serviced. Servicing the engine within a reasonable timeframe after a notification with the servicing recommendation is received may result in a lower service rate or preferred coverage for the user 18 and/or the vehicle 12. However, if the user 18 ignores the recommendations and drives the vehicle 12 until it breaks down and subsequently requests a towing service, then this may results in an increased rate immediately or in the future. In another example, compliance data may include information regarding whether a user 18 has followed an alternative route suggestion recommended via notification received at onboard device 14 or computing device 24, where the suggestion is prompted by an icy road warning issued by central server 16. If the user 18 repeatedly chooses to ignore icy road warnings and associated alternative route suggestions, and in one occurrence drives the vehicle 12 into a ditch due to the icy road conditions, then the service rate associated with the user 18 or the vehicle may be adversely impacted (i.e., increased) immediately or in the future. The service rate may also be adversely impacted (i.e., increased) based on certain non-compliance behaviors of the user 18 even if no major road accidents or hardware defect has occurred as a result of the non-compliance behavior. Telemetry data used to determine compliance data can be gathered in a number of ways by compliance device module 64 from onboard device 14 coupled to onboard sensors, as described in detail herein. As noted, the vehicle record (e.g. service, mileage, make, model, maintenance history) may be considered as metrics. The onboard device may also monitor for warning codes in vehicle 12 and collect data regarding the warning codes (code would clear when repair, hard or soft codes, program device 14 to detect when critical codes or all codes are activated and report the code to the system 10).

The service rate or coverage may be associated with a membership with a vehicle service provider (e.g. road side assistance), where the membership is associated with a user 18, vehicle 12, or a combination of user 18 and vehicle 12. The service rate or coverage may be associated with insurance, where the insurance is associated with a user 18, vehicle 12, or a combination of user 18 and vehicle 12. Accordingly, user profiles may be correlated with vehicle profiles to calculate the service rate or coverage, or may be considered separately.

Other factors may also be considered, such as the age of the user 18. Young drivers may by default be given high rates or restricted coverage (e.g. driveway coverage, highway coverage). Their compliance may be monitored to differentiate between young drivers. A usage based service rate or coverage may be based on monitored compliance data, and the user 18 may have access to the data used to calculate their service rate or coverage to improve.

As another example, a service provider profile may include information regarding service providers, such as company name, identifier, password(s), address, information regarding type of service provided, geographic area for providing service, and so on. Bid records include information collected regarding bids received in response to specific service/bid requests including an indication of the selected bid. Service provider profile may include historical data in relation to service providers, users (e.g. demographic data), services, service rates, and so on that may be processed by central server 16 to provide a reasonable rate for a user, and so on. Service provider profile may include industry data and statistical data for use in computing rates. Service provider profile may also include feedback data received from users regarding service providers or received from service providers regarding users, and so on. Feedback data may also include third party data such as reviews, ratings, etc. Feedback data may be processed by central server 16 to provide recommendations to user in relation to service providers, and so on.

Profile module 34 is operable to authenticate each user 18 and service provider. In some examples, a user 18 may be required to authenticate in order to communicate with the central server 16, configure its associated profile, receive reports, and so on. For example, each of the users 18 may be required to input a user identifier such as a unique code, login name, and/or a password associated with that user 18, or otherwise identify the user to gain access to the central server 16. Similarly, a service provider may be required to authenticate their identities in order to communicate with the central server 16, configure its associated profile, receive reports, and so on. For example, each of the service providers may be required to input a service provider identifier such as a login name, and/or a password associated with that service provider or otherwise identify themselves to gain access to the central server 16. Profile module 34 may ensure that only legitimate users and service providers are requesting access to central server 16 and the associated profiles. In some examples, one or more users (e.g., “guest” users) or service providers may be able to access the central server 16 without authentication. Such guest users or service providers may be provided with limited access and may not be able to perform specific actions. Profile module 34 may be further operable to generate authentication data in relation to a legitimate server provider for use when they arrive to provide the requested service. For example, profile module 34 may provide a unique barcode to service provider associated with the selected bid for display on their device. When the service provider arrives at the vehicle 12 location then the user's device 14 may provide a scanning tool to scan the barcode displayed on the service provider device and provide the scanned data to profile module 34 to perform a matching to the unique barcode of service provider to confirm that it is the legitimate service provider onsite. Other onsite authentication mechanisms may also be used such as a passcode, photo, and so on. Profile module 34 may store a record in the profile associated with service provider, where each record may be retrieved using an identifier or data indicating a barcode or other authentication mechanism for the service provider. This may help a user avoid getting service by an illegitimate service provider.

In accordance with some embodiments, central server 16 is operable to receive feedback data from users in relation to one or more service providers and provide the received feedback data to profile module 34 for recordal as feedback records in the corresponding service provider profile. Central server 16 is operable to receive feedback data from service providers in relation to one or more users and provide the received feedback data to profile module 34 for recordal as feedback records in the corresponding user profile. Central server 16 is further operable to generate feedback reports specific to a user or service provider by interacting with profile module 34 to retrieve and aggregate feedback records specific to a user profile or service provider profile.

In accordance with some embodiments, central server 16 is operable to provide configuration or preference options to onboard device 14 (or computing device 24 used by user) and receive configurations in response. The device 14 may be associated with a user identifier corresponding to a user profile, and the configurations received from device 14 may be stored by profile module 34 as a configuration record in the corresponding user profile. For example, the user may configure format and type of notifications and reports. The user may also add one or more vehicles 12 or devices 14 to be associated with the user identifier (and in turn the user profile), where each of the vehicles 12 associated with the user profile may or may not has a vehicle profile on its own. If the vehicle 12 has an existing vehicle profile, it may be further linked to the user profile. As a further example, a user may configure preferred service providers (e.g. service providers that they would like to receive service from) and may also configure a blacklist of service providers (e.g. service providers that they would not like to receive service from) for use to suggest service providers to users if an incident with vehicle 12 is detected.

Data aggregator module 36 is operable to correlate the collected vehicle data sets based on a variety of factors, in order to group data sets relating to a particular location or area, a particular vehicle 12, a particular user 18, a particular time, and so on. Data aggregator module 36 is operable to filter the collected vehicle data sets to remove unwanted or irrelevant data. Data aggregator module 36 is operable to perform error correction on collected telemetry data, and data collected from other sources. For example, a time and date may be clearly erroneous (e.g. 20 years ago) and that data may be ignored for calculation purposes.

Cost calculation module 38 is operable to compute service rates for services provided by service providers. The service rates may be specific to a user and may be calculated based on metrics stored in the user profile. For example, the service rates may be proportional to the driving behavior of a user 18. This may be determined based on telemetry data collected in response to transmitting a notification with a recommended vehicle action to an onboard device 14, computing device 24, or other output device such as an electronic sign, for example. The compliance data may indicate compliance with the vehicle action. The cost calculation module 38 may retrieve service rates from service provider profiles in order to calculate a service rate for a particular user 18 or a particular vehicle 12. The cost calculation module 38 may also access historical records and industry/statistical records in order to determine the service rate. The cost calculation module 38 may store the calculated service rate in the user profile for the particular user (and/or the vehicle profile for a particular vehicle). The cost calculation module 38 may adjust the service rate after additional compliance data is computed, after a particular period of time, and so on, as described below.

As described above, the cost calculation module 38 may determine a service rate that is charged per person, per vehicle, per certain amount of road or mileage coverage, or based on any combinations thereof. The main metrics considered in calculating a service rate can include vehicle record, personal driving history, individual characteristics, and compliance data, all of which are described in detail below. The main metrics may also include data from the abovementioned user profile or vehicle profile where appropriate.

Vehicle record can include service or maintenance history, mileage amount and history, brand, model and make of the vehicle, active error/fault/trouble code(s) in the onboard diagnostic system, location of parking garage(s), GPS history, most current detectable location, and so on.

Personal driving history can include traffic tickets, at-fault accidents, no-fault accidents, parking tickets, most commonly drive route(s), driving habits, and so on.

Individual characteristics can include if a user is sleep deprived, a drug addict, a substance abuser, age, weight, height, educational background, physical or mental disability, and so on.

Compliance data can include data indicating compliance with the vehicle action. As will be described in greater detail below, compliance module 46 of is operable to collect telemetry data and process the telemetry data to determine compliance with the recommended action. Metrics related to the compliance data may be stored in user or vehicle profile and used to calculate service rates for users or vehicles. For example, a recommendation may be to service an engine in a particular amount of time. Compliance data may indicate whether or not the engine was serviced. Servicing the engine within a reasonable timeframe after a notification with the servicing recommendation is received may result in a lower service rate for the user and/or the vehicle. However, if the user ignores the recommendations and drives the vehicle 12 until it breaks down and subsequently requests a towing service, then this may results in an increased rate immediately or in the future. In another example, compliance data may include information regarding whether a user has followed an alternative route suggestion recommended by onboard device 14, where the suggestion is prompted by an icy road warning issued by central server 16. If the user repeatedly chooses to ignore icy road warnings and associated alternative route suggestions, and in one occurrence drives the vehicle into a ditch due to the icy road condition, then the service rate associated with the user or the vehicle may be adversely impacted (i.e., increased) immediately or in the future. The service rate may also be adversely impacted (i.e., increased) based on certain non-compliance behaviors of the user even if no major road accidents or hardware defect has occurred as a result of the non-compliance behavior. Compliance data can be gathered in a number of ways by compliance device module 64 from onboard device 14, as described in detail below.

The service rate or coverage may also be based on additional information from vehicle data sources and other data sources 30 such as a pre-set geofence, after-market modifications to a vehicle, most frequent parking area(s) for the vehicle, most common timeframes (e.g. rush hour or midnight) during which the vehicle is typically driven, whether the vehicle experiences a lot of braking or accelerating action, whether the user tends to drive dangerously close to other automobiles on the road, whether the vehicle has night light on while driving in dim lighted conditions, whether the vehicle uses fog lights in heavily fogged areas, a user's driving habits during certain (e.g., rainy or stormy) weather conditions, and so on. Some of the additional information may overlap with data field(s) included in vehicle profile, vehicle record, personal driving history, or individual characteristics of a user. A service provider or system administrator may set or adjust the categories to which each data field belongs, and that regardless of said categorization, a relevant data field may be weighed differently from another while taken into consideration in determining a service rate by the cost calculation module 38.

Accordingly, a variety of factors may be considered for the service rate, coverage, or recommendation such as vehicle maintenance/safety, after market changes to vehicle, driver characteristics (e.g. substance problems), location (parked outside of the bar for six hours then may be drunk, sleep patterns (tired driver, trucking companies), weather, proper tires (RFID tires, dealer, access port), driving habits in bad weather, driving location history (local driver, cross country drive, drive outside of coverage area, lower rate or different coverage based on where you drive, driving near known dangerous locations, where you are driving in view of where your car is garaged/where you live, geofence around coverage area, traffic, stop and go (rear ending), frustration, fuel consumption, events (leads to increased traffic), time of travel (use historical data to suggest alternative times), lane drifting, points of interest, recommendations regarding hotels and determining whether they comply with it to tailor recommendations, radio sound level and other distractions, and so on. These are non-limiting examples only.

Condition module 40 is operable to store conditions that may be applied to collected vehicle data sets to determine when a notification should be transmitted to an onboard device 14. If the collected vehicle data sets meet one or more conditions then this triggers generation and transmission of a notification. The conditions may be associated with one or more recommended vehicle actions that may be included in the notification. For example, if the vehicle data sets indicate that there is a traffic accident ahead detected from other vehicles 12 already at the accident location and the vehicle 12 is heading towards the accident then this may trigger a notification to that onboard device 14 in the vehicle 12 and the recommended vehicle action may be take an alternative route. Accordingly, conditions may relate to measurements of traffic flow and location of other vehicles. Traffic flow measurements may include traffic conditions, average speed of vehicles, total volume of vehicles, weather, problems with vehicle, and other measurements.

The conditions stored in condition module 40 may be modified or deleted by the appropriate personnel (e.g. service provider or system administrator). A list of exemplary conditions and corresponding notifications or recommended actions may include, but is not limited to:
In the event of detecting sudden airbag deployment, send a notification to inquire if the driver and occupants need emergency assistance;
In the event of detecting repeated sudden brakes or ABS application, send a notification to remind the user to drive safely;
In the event of detecting a vehicle velocity exceeding the current speed limit by a certain threshold, send a notification to remind the user to slow down and drive in accordance with the imposed speed limit X miles or km/hour;
In the event of detecting a vehicle leaving a geofenced area, send a notification to remind the user that the vehicle is leaving a geofenced area, and may send a notification to persons registered in the database (e.g. if a young driver is leaving geofenced area downtown Toronto, a parent may be notified right away);
In the event of detecting a wrong or unexpected driver by onboard device 14, either through failed attempts of logging into system 10, or grossly mismatched user weight on driver's seat, send a notification to the registered user and may also send a notification to the appropriate personnel (e.g. police may be notified if the vehicle appears to be stolen);
In the event of suddenly detecting deceleration of vehicle without application of the brakes (i.e., an accident may have happened), send a notification to the user asking if emergency assistance is required;
In the event of receiving user instructions via onboard device 14 requesting roadside assistance or recommendations, send notifications addressing the request;
In the event of detecting seat belt not buckled properly at a seat on which a substantial weight is placed, send a notification alerting the user regarding the seat belt;
In the event of detecting a sudden rapid loss of tire pressure (i.e., a flat tire may have happened), send a notification alerting the user to the flat tire and asking if any assistance is required;
In the event of detecting 1) a key in the ignition, 2) doors are locked and 3) nobody is in the car (via weight sensors), sending a notification to a user's registered mobile phone, device 14, computing device 24 or email inquiring if any assistance is required;
In the event of detecting a user entering a dangerous driving zone such as icy road condition, send a notification alerting the user to the dangerous driving condition;
In the event of detecting alcohol via onboard breathalyzer or air content analyzer, send a notification requesting the user to slow down in a safe area and cease driving;
In the event of detecting a lane change or a turn of the vehicle with turn signals off, send notification alerting user to proper use of turn signals;
In the event of low fuel level, send a notification alerting user to add fuel as soon as possible;

and many others.

Recommendations may be personalized to users 18, and different users 18 may get different recommendations and may be associated with different vehicle conditions which trigger the notification and recommendation.

Central server 16 generally includes one or more data storage devices (e.g., memory, and the like), and could include a relational database (such as a SQL database), or other suitable data storage mechanisms. Data storage module 42 is operable to manage the storage and retrieval of data entries in the data storage devices. The data storage devices are configured to store and maintain data records about the data collected from devices 14 and other data sources, user profiles for users 18 of system 10, vehicle profiles for vehicles 12 of system 10, conditions for identifying with notifications should be sent, compliance data about response to notifications with recommendations, along with processed data and other metrics computed by central server 16. Data storage devices may also store metadata about the collected data, user profiles, vehicle profiles, compliance data, conditions, service providers, attributes of the users and collected data, and so on. Data storage devices are operable to store content for Central server 16 such as content for provision to devices 14, computing device 24, and so on.

Data storage module 42 may also store authorization criteria that define what actions may be taken by the users (via device 14 or computing device 24) and service providers (via computing device 24 or other connect device). The authorization criteria may be included in user and service provider profiles. In some embodiments, the authorization criteria may include at least one security profile associated with at least one role to differentiate between different types of users and service providers. Users with a specific role may have a security profile that allows them to configure the service request and user preferences, and so on. Service providers with a specific role may have a security profile that allows them to configure the bids and service provider preferences or configurations, and so on.

In some embodiments, some of the authorization criteria may be defined by specific users. For example, administrator users may be permitted to administer and/or define global configuration profiles for the system 10, define roles within the system 10, set security profiles associated with the roles, and assign the roles to particular users and service providers of the system 10. In some cases, the administrative users may use another computing device and an administrative application to accomplish these tasks.

In some embodiments, the central server 16 may also have one or more backup servers that may duplicate some or all of the data stored on the data storage devices. The backup servers may be desirable for disaster recovery (e.g., to prevent undesired data loss in the event of an event such as a fire, flooding, or theft). In some embodiments, the backup servers may be directly connected to the central server 16 but located at a different physical location.

Notification module 44 is operable to generate and transmit notifications to onboard devices 14. Notification module 44 is operable to interact with condition module 40 to determine if the collected vehicle data sets meet one or more conditions to trigger generation and transmission of a notification. The conditions may be associated with one or more recommended vehicle actions. Notification module 44 is operable to generate a notification including one or more recommended vehicle actions.

Notification module 44 may generate a notification that includes a recommended vehicle action. For example, central server 16 may detect that one vehicle 12 component is about to fail, such as an engine, and transmit a notification indicating that the engine should be serviced. The notification may also recommend service providers that may service the engine, based on a number of factors such as the current location of the vehicle 12. A user may also explicitly request a recommendation for a service provider and in response the notification module 44 may send an additional notification including one or more recommended service providers. The recommendation may also relate to a different service provider and a different service than requested by the user, such as a complementary service. For example, if the vehicle 12 breaks down or is in an accident the recommendation may recommend a tow for a vehicle from a current location to a destination and a repair garage or body shop located proximate to the destination or current location to repair the vehicle 12.

Compliance module 46 is operable to collect telemetry data and process the telemetry data to determine compliance with the recommended action. Metrics related to the compliance data may be stored in user or vehicle profile and used to calculate service rates for users or vehicles. For example, a recommendation may be to service an engine in a particular amount of time. Compliance data may indicate whether or not the engine was serviced. Servicing the engine within a reasonable timeframe after notification module 44 sends a notification with the servicing recommendation to a user may result in a lower service rate for said user or said vehicle. However, if the user ignores the recommendations and drives the vehicle 12 until it breaks down and subsequently requests a towing service, then this may results in an increased rate immediately or in the future. In another example, compliance data may include information regarding whether a user has followed an alternative route suggestion recommended by onboard device 14, where the suggestion is prompted by an icy road warning issued by central server 16. If the user repeatedly chooses to ignore icy road warnings and associated alternative route suggestions, and in one occurrence drives the vehicle into a ditch due to the icy road condition, then the service rate associated with the user or the vehicle may be adversely impacted (i.e., increased) immediately or in the future.

Central server 16 may also include a payment module (not shown) operable to process payments for service rates or membership fees. Central server 16 may coordinate payment of service rates or membership fees between a user 18 and a server provider. Payment module is operable to prompt device 14 or computing device 24 for payment based on a service rates or membership fees calculated by the cost calculation module 38 and stored in the user profile or the vehicle profile. Payment module is operable to receive payment details from device 14 or computing device 24 and process the payment or engage a third party payment platform to process the payment. Payment module is operable to provide payment to the respective service provider who is providing the service or engage the third party payment platform to provide payment to the service provider. Payment module is operable to a service provider regarding received payments. Payment module is operable to charge the user or the service provider an administration fee for using the service and may add or deduct the administration fee from the payment.

Referring now to FIG. 3, there is shown a block diagram of an on-board device 14 for collecting data related to vehicle 12. Onboard device 14 may include a computing application, application plug-in, a widget, instant messaging application, mobile device application, e-mail application, online telephony application, java application, web page, or web object residing, executing, running or rendered on the onboard device 14 in order to access the functionality of central server 16. The application may be implemented by a processor of the onboard device 14 executing instructions stored on a data storage device of the onboard device 14.

The application may configure onboard device 14 with a number of functional modules such as device interface module 52, a data collection module 54, a data processing module 56, an input/output module 58, a device notification module 60, a device storage module 62, and a device compliance module 64. The application may provide a user interface for receiving and displaying data about the vehicle. Device 14 is operable to communicate and exchange data with central server 16. A communication bus (not shown) enables asynchronous communication and data exchange between the onboard device 14 components. The components of the onboard device 14 are modular and can function independently or together. The onboard device 14 may include a touch screen or other input/output mechanism for user to interact with.

Device interface module 52 may interface with external and internal data sources 50, such as sensor data sources, onboard diagnostic data sources, a navigation system, a diagnostic tool, vehicle telematics devices, global positioning system, a clock, and other data sources. Device interface module 52 is operable to perform format conversion on raw data and may also normalize raw data for provision to data collection module 54. Device interface module 52 is operable to interact with mechanical and electrical systems of vehicle 12 in order to remotely control components of vehicles, such as locks, for example. Examples include unlock doors, deactivate codes, roll down windows, open trunk, slow and stop a vehicle 12. Further examples include, disable your vehicle 12 remotely, if the vehicle 12 is in an unsafe condition then can remotely service, charging for electric vehicles (test cycle for charging, when did the user 18 plug in, how long was the user 18 plugged in, etc.).

The sensor device sources interfacing with device interface module 52 to provide vehicle telemetry data may include, but are not limited to, the following types of sensors: air content analyzer, breathalyzer, air-fuel ratio meter, blind spot monitor, crankshaft position sensor, curb feeler or detector, engine coolant temperature sensor (or ECT sensor), hall effect sensor, Manifold Absolute Pressure or MAP sensor, mass flow sensor or mass airflow (MAF) sensor, oxygen sensor, parking sensor, radar gun, speedometer, speed sensor for external objects, throttle position sensor, tire-pressure sensor, torque sensor, torque transducer, torque meter, transmission fluid temperature sensor, turbine speed sensor (TSS), input speed sensor (ISS), variable reluctance sensor, vehicle speed sensor (VSS), water sensor or water-in-fuel sensor, wheel speed sensor, accelerometer, odometer, position sensor, sudden motion sensor, gyroscopic sensor, tilt sensor, lane sensor, distance sensor (to external objects), brake sensor, seat belt sensor and maintenance sensor/log. Each of these sensors may form part of the onboard diagnostic system or exist as a standalone sensor that can interact with onboard devices 14.

Non-limiting examples of telemetry data collected by the sensors may include: revolutions per minute, transmission setting, throttle position, engine coolant temperature, intake air temperature, barometric pressure, brake lights on/off, turn signal on/off, headlamps on/off, hazard lights on/off, back-up lights on/off, parking lights on/off, dim lights on/off, fog lights on/off, high beam lights on/off, wipers on/off, doors locked/unlocked, key in ignition, key in door lock, key in trunk lock, horn applied, airbag deployment, brakes applied, ABS application, level of fuel in tank, radio station on/off, mobile phone on/off, in-car entertainment system on/off, seat belt on/off, door on/off, position of each window, tail gate open/closed, odometer reading, accelerator reading, speed reading, cruise control active/inactive, anti-theft active/inactive, weight of each occupant, geographic location of vehicle, current date and time, traveling direction, Intelligent Vehicle Highway System (IVHS) data, distance to external objects, and whether the driver is intoxicated (via onboard breathalyzer or air content analyzer).

Device interface module 52 may provide user authentication to authenticate a user 18 (using a login and password for example) prior to providing access to the functionality provided by onboard device 14 and applications residing thereon. Further, the same onboard device 14 may some one user 18 or multiple users 18, and authorization provides a mechanism to distinguish between the multiple users 18. Authentication may ensure that a legitimate user is using onboard device 14, as vehicle data collected from device 14 may influence the service rates the corresponding user 18 is charged. In some examples, one or more users (e.g., “guest” users) may be able to access the user application 18 without authentication. Such guest users may be provided with limited access and may not be able to perform specific actions. The user authentication may be further operable to perform onsite authentication of a service provider to confirm the service provider that arrives to the location of the vehicle 14 is legitimate. As noted, this may be accomplished through a barcode to be scanned from a device of the service provider by the user (reconciliation) or via a pin or pass number provided by the service provider and confirmed by the user authentication. A scanning tool may be provided to receive the authentication data from the service provider.

Data collection module 54 is operable to receive data from device interface module 52 for provision to central server 16, for storage with device storage module 62, or both. Data collection module 54 may aggregate the received data for provision to data processing module 56 prior to sending the data to central server 16. Data collection module 54 may store conditions to trigger what data is sent to central server 16.

Data processing module 56 is operable to filter the collected vehicle data sets to remove unwanted or irrelevant data. Data processing module 56 is operable to perform error correction on collected telemetry data. For example, a time and date may be clearly erroneous (e.g. 20 years ago) and that data may be removed. Further, data processing module 56 may group data sets for a specific time period. Data processing module 56 may also locally store conditions relating to vehicle data which may trigger the transmission of data to central server 16.

Input/output module 58 is operable to interface with output devices in vehicle 12 and onboard device 14, such as speakers or display, for example. Input/output module 58 is operable to interface with input devices in vehicle 12 and onboard device 14, such as a microphone and keypad, for example. Input/output module 58 is operable to provide a user interface to exchange data with user 18.

Input/output module 58 is operable to receive feedback data from users in relation to one or more service providers and provide the received feedback data to central server 16. Input/output module 58 may provide a questionnaire, a like/dislike icon, a star rating, form field or other mechanism to receive feedback regarding a service provider. Input/output module 58 is operable to receive feedback reports regarding service providers from central server 16, and display those feedback reports to user. The feedback reports may include feedback received from other users or may be specific to a user.

Input/output module 58 is operable to provide configuration or preference options and receive selected configurations in response. Input/output module 58 may receive updates for configuration options from profile module 34 of central server 16. Input/output module 58 is operable to provide configurations received from user to profile module 34 of central server 16 where they may be stored by data storage module 42 as part of the user profile. For example, the user may configure the type of notification and the format of the notification. As a further example, a user may configure preferred service providers (e.g. service providers that they would like to receive service from) and may also configure a blacklist of service providers (e.g. service providers that they would not like to receive service from). Input/output module 58 is operable to store received configurations locally in via device storage module 62.

Input/output module 58 may provide an interface with a payment form for receiving payment details to pay for service rate or membership rate, or for a specific service prior to or after receiving the service. Input/output module 58 is operable to provide the received payment details to central server 16 for processing, or to engage a third party payment platform to process the payment.

Device notification module 60 is operable to communicate notifications received at onboard device 14. Device notification module 60 is operable to interact with input/output module 50 to access output devices to communicate the notification to user 18. The notifications may be text, speech, visual, and so on. The notification including one or more recommended vehicle actions.

Device compliance module 64 is operable to collect telemetry data used to determine compliance data in response to receiving a notification with a recommendation, or receiving an instruction to monitor for compliance. Compliance data may be received from a variety of data sources 50, such as sensors, onboard diagnostics and so on. The compliance data indicates compliance with the recommended vehicle action. Telemetry data may be any collected vehicle data after the notification was communicated to the user 18. Compliance data may also be filtered vehicle data targeting indicators of compliance based on the recommendation. For example, indicators of compliance may be maintenance or service data, vehicle speed, braking data, and so on.

Device storage module 62 may store and retrieve data locally on the data storage device of onboard device 14 or may be otherwise accessible by the onboard device 14. The amount of data saved in the onboard device 14 may be constrained based on the amount of memory of onboard device 14. Device storage module 62 may contain a registration record of data that may be automatically provided to central server 16 to authenticate the user (such as a digital certificate, username, password, and so on). Device storage module 62 may contain recently received notifications, recently collected vehicle data, compliance data, and so on. Device storage module 62 may also contain historical records. Device storage module 62 may also include feedback records of reviews, ratings and feedback received from user to provide user preferences. Device storage module 62 may also include vehicle data from data processing module 56 and data collection module 54, such as for example, sensor data, onboard diagnostic data, global positioning data, navigation data, telematics data, diagnostic data, and so on. These are examples only and some data records may not be stored on onboard device 14 especially if there is limited memory available on the data storage device of the onboard device 14. Further, some or all data records may instead or additionally be stored on data storage module 42 of central server 16 and may be accessible to onboard device 14.

Reference is now made to FIG. 4 which illustrates a flow chart diagram of a method 100 for determining compliance with vehicle recommendations according to one or more embodiments.

At 102, registration information is received from users and service providers at profile module 34 for example, in order to create a profile for users, vehicles and service providers. A user or service provider may be required to create an account or login to an existing account. As an illustrative example, the service providers may provide a variety of services such as vehicle insurance, roadside assistance (e.g. vehicle tows), and so on. A user may be a member of the service provider to receive services or otherwise subscribe to one or more services provided by service provider. The service providers may register by providing the required information, such as company name, address, email, phone number, types of services provided and so on. A service provider can register via a web interface to central server 16, for example. The service provider may be required to create a service provider account accessible via a service provider identifier (e.g. username and password) in order to authenticate with central server 16. When a service provider registers a unique barcode, passcode, or other authorization mechanism may be linked to the specific service provider and stored in the service provider profile for onsite authorization of the service provider. Profile module 34 is operable to add the received registration data to a corresponding service provider profile for storage at data storage module 42. The service provider profile may include the authorization data for the service provider, as well as a geographic location or area for the service provider and types of services provided by service provider. A service provider may associate rates with each type of service which may also be stored in service provider profile.

A user may subscribe or register by downloading an application to onboard device 14 and providing the required information, such as name, address, phone number, vehicle details, and so on. The user may also indicate a service provider of which they are a member, along with a membership identifier in order to link the user to a service provider and the rates associated with the provided services. Alternatively, a user can register via an application or web interface to central server 16 on computing device 24. The user may be required to create a user provider account accessible via a user identifier (e.g. username and password) in order to authenticate with central server 16. The received registration data is provided to profile module 34 to include in a user profile as metrics. The data storage device 42 may store the user profile or vehicle profile, and onboard device 14 may locally store the registration data and user or vehicle profile. User 18 may associate one or more onboard devices 14 with their user profile. User 18 may associate one or more vehicles 12 with their user profile, regardless of whether the one or more vehicles 12 have their corresponding vehicle profiles. A vehicle profile may be associated with a vehicle 12 and one or more users 18. Vehicle data associated with the user and collected by central service 16 may be processed and stored in their user profile as metrics. The vehicle data may also be stored in a vehicle profile. The metrics recorded in the user or vehicle profile may be used to compute one or more service rates or service levels for services provided to user. The service rate may correspond to the rate for providing one or more services, and the service level may define service coverage. Accordingly, each user may be associated with one or more service providers and one or more vehicles, which are linked thereto via a user identifier, vehicle identifier or service provider identifier.

At 104, central server 16, and in particular profile module 34 is operable to store user/vehicle profiles and service provider profiles. Each user profile is indexed using a user identifier corresponding to a user and metrics. Each vehicle profile may be indexed using a vehicle identifier corresponding to a vehicle (or a user identifier corresponding to a user) and metrics. The information and data received from users 18, vehicles 12, and service providers are stored in the user profiles, vehicle profiles and service provider profiles as metrics. The metrics may be used in determining a service rate or service coverage for the user or vehicle. Non-limiting example metrics include age, gender, occupation, vehicle data, and so on. The vehicle data may include vehicle telemetry data. The vehicle telemetry data may be collected from sensor devices located in vehicle 12 (via onboard device 14, for example). Other example sensor devices are described herein.

At 106, central server 16 collects vehicle telemetry data and data from other data sources 22. The vehicle data may be collected from telemetry devices, such as onboard device 14 located in a vehicle 12. The onboard devices 12 may be referred to as a vehicle sensor device and is coupled to one or more vehicle sensors. A variety of example sensors are described herein. Each onboard device 14 may be associated with a user identifier corresponding to a user. An onboard device 14 may also be associated with a vehicle identifier corresponding to a vehicle 12. Accordingly, the onboard device 14 is also associated with one or more vehicles 12, and is operable to collect vehicle telemetry data regarding the vehicle 12 from various data sources 50.

In accordance with some embodiments, central server 16 may collect vehicle telemetry data sets from multiple onboard devices 14 and from a variety of data sources 30. Central server 16 is operable to correlate collected vehicle telemetry data based on a variety of factors, such as user identifier, timestamp, location, and so on. The central server 16 processes the telemetry data to derive different metrics for evaluating compliance with recommended vehicle actions. The metrics may provide information about a condition of the vehicle, a manner of operating the vehicle, and a condition of an environment for the vehicle. The telemetry data may be collected by multiple devices that independently relay data to the central server 16. The central server correlates and matches the telemetry data to determine compliance remotely from the vehicle 12. In some embodiments, the onboard device 14 also communicates the recommendation within the vehicle 12 in near-real time in a preventive manner. This recommendation enables vehicle 12 to avoid a potential incident by transmitting the recommendation as an alert. The recommendation may alert the vehicle 12 to upcoming unsafe conditions and suggest an alternative route or speed. The recommendation may alert to upcoming traffic conditions. The recommendation may alert to a problem within the vehicle 12. Other examples are provided herein.

For example, the collected telemetry data may indicate that the vehicle 12 is about to break down due to engine problems. The onboard device 14 may collect this information from a variety of data sources 50 and may have or interface with GPS hardware/software (or other location determination device) to automatically obtain location information and send the vehicle telemetry data and location information to the central server 16. A user 18 may also manually input data into onboard device 14, such as any known issue with the vehicle, a requested service, destination, and identify if the vehicle should be taken to a garage or home. The onboard device 14 may interface and connect with sensor devices and telematics devices of the vehicle 12 so that onboard device 14 can receive information from the vehicle via a connector to the sensor devices (e.g. Bluetooth, WiFi, OBD port and so on). The vehicle information may also include a make and model of the vehicle 12. The data may relate to multiple conditions and factors about the vehicle, such as a preferred tow service and a preferred garage service, for example. The location may be general, such as a city or a region, or may be specific such as a street address. The vehicle telemetry data sets may be time-stamped, and may also have other data attributes such as location, user identifier, service provider, and so on. Central server 16 is operable to process and store the collected vehicle telemetry data.

At 108, central server 16 transmits a recommendation to an output device, such as a display or output component of an onboard device 14. The recommendation may be triggered when a vehicle condition is met by the collected vehicle telemetry data sets. The vehicle telemetry data may be collected from other vehicles 12 and may also be collected from the same vehicle that recommendation was transmitted to. The vehicle condition may be a rule defining specific condition that needs to be met by the telemetry data in order to trigger a recommendation for the vehicle 12. Central server 16, and in particular, condition module 40 is operable to store conditions that are matched to collected, correlated, and processed vehicle telemetry data sets to trigger transmission of a notification. The notification may include a recommended vehicle action. For example, vehicle data sets may indicate that it is raining and that traffic is slowing at a location the vehicle is proximate to and heading towards. The recommended action may be to slow the vehicle to a particular speed or to take an alternative route. The recommendation may also be transmitted periodically to the user 18 as a summary report via computing device 24, for example. The recommendation may also be provided via an electronic sign proximate to the roadway and observable from vehicle 12.

As noted above, central server 16 is operable to correlate collected vehicle telemetry data based on a variety of factors and the recommendation may be triggered when a vehicle condition is met by the correlated vehicle telemetry data sets.

At 110, central server 16 collects further vehicle telemetry data from onboard device 14 to determine compliance with the recommendation. The compliance data indicates compliance with the recommended vehicle action. Referring back to the above example, if the recommended action was to slow the vehicle to a particular speed, then the compliance data would indicate whether the vehicle 12 did slow to the recommended speed. The speed of the vehicle and other telemetry data may be collected to determine compliance with the recommendation. Compliance data may be collected at onboard device 14 from various data sources 50, such as sensors, onboard diagnostics and so on, and transmitted to central server 16.

A list of exemplary compliance with the recommended vehicle actions may include, but is not limited to:
After detecting frequent sudden brakes or ABS application and sending a notification to drive safely, and within a threshold timeframe (e.g. 5 or 10 minutes), less frequent sudden brakes or ABS applications are detected;
After detecting a vehicle velocity exceeding the current speed limit by a certain threshold and sending a notification to remind the user to slow down and drive in accordance with the imposed speed limit X miles or km/hour, and within a threshold timeframe (e.g. 1 or 2 minutes), the vehicle starts and maintains traveling at a speed that is less than the current speed limit;
After detecting a vehicle leaving a geofenced area and sending a notification to remind the user that the vehicle is leaving a geofenced area, and within a reasonable timeframe, the vehicle returns to the geofenced area;
After detecting a seat belt not buckled properly at a seat on which a substantial weight is placed and sending a notification alerting the user regarding the seat belt, the seat belt is subsequently buckled properly;
After detecting a user entering a dangerous driving zone (e.g. icy road condition) and sending a notification alerting the user to the dangerous driving condition, the vehicle either slows down or takes an alternative route;
After detecting alcohol via onboard breathalyzer or air content analyzer and sending a notification requesting the user to slow down in a safe area and cease driving, the vehicle slows down within a reasonable timeframe and stops entirely;
After detecting a lane change or a turn of the vehicle with turn signals off, and sending notification alerting user to proper use of turn signals, the turn signals are detected to be on next time the vehicle makes a lane change or turn;
After detecting low fuel level and sending a notification alerting user to add fuel as soon as possible, within a reasonable timeframe the fuel level is detected over 50% full in the vehicle gas tank;
   and many others.

Central server 16 is operable to detect patterns and subsets of information within the telemetry data to determine whether a recommendation should be sent and to determine compliance with the recommendation. Patterns may be defined as vehicle conditions, where a vehicle condition is linked to a recommendation such that when the condition is met by telemetry data (or other collected data), then the linked recommendation triggers. The patterns may be applied to collected telemetry data to trigger recommendations if a match is determined. Further, the recommendation (e.g recommended vehicle actions) may also be linked to the patterns indicating compliance. The patterns indicating compliance may be applied to collected telemetry data to determine compliance based on whether a pattern matches the collected telemetry data.

At 112, central server 16 records additional metrics in the user profile or vehicle profile associated with the onboard device 14 the compliance data was received from. An additional metric may include a compliance metric based on the compliance data. Various types of data regarding the compliance data and the associated recommendation may be recorded in the user or vehicle profile. The recorded data may be used to generate reports about recommendations and compliance, as well as determine service rates and service coverage.

At 114, central server 16 is operable to determine or adjust the service rate or service coverage in the user profile or vehicle profile associated with the device 14 the compliance data was received from. Central server 16 is operable to determine or adjust the service rate based on the additional metric. For example, the service rate may relate to an insurance rate. If the recommended action was to slow the vehicle to a particular speed and the compliance data indicates that the vehicle 12 did slow to the recommended speed then the insurance rate may be lowered as this may indicate that the driver is careful and follows safety recommendations. If the recommended action was to slow the vehicle to a particular speed and the compliance data indicates that the vehicle 12 did not slow to the recommended speed then the insurance rate may be increased as this indicates that the driver user 18 may be careless. Central server 16 may repeat steps 108 and 110 to collect a large amount of compliance data to give a more accurate representation and larger sample size, and adjust the rate accordingly.

Referring now to FIGS. 5 and 6, there is shown schematic diagrams a variety of vehicle related services. The services include insurance, such as usage based insurance, a vehicle continuously connected to central server 16 via an on-board device 14, and remote vehicle diagnostics and control. FIG. 5 illustrates a schematic diagram 200 of an intersection between different services that may be provided by system 10 to user 18, such as insurance, vehicle diagnostics, and a connected vehicle (via onboard device 14). FIG. 6 illustrates another schematic diagram 300 of different services that may be provided by system 10 to user 18, such as insurance, vehicle diagnostics, and a connected vehicle.

System 10 is operable to collect and apply user and vehicle information to provide differentiated, value-added services. Services may assist in providing longer automobile life, increased reliability, and reduced need for regular maintenance. System 10 may enable proactive user contact via notifications, relevant service delivery or recommendations, and timely, convenient follow-up. System 10 may integrate vehicle data compiled from repair and road service networks, repair shop systems, industry sources, and so on. The addition of telematics through onboard device 14 provides real-time, expanded access to data relating to vehicle 12. A detected roadside battery boost could lead to user contact regarding battery replacement. Enhanced interfaces may be provided to gather and share data with users, external data suppliers and employees so that system 10 is a “one-stop” access to vehicle maintenance and repair tools, car buying applications, driver training information, and roadside assistance. System 10 may trend vehicle 12 service by specific year/make/model and provide clubs with information to advise members about routine maintenance. System 10 may provide users with vehicle alerts, maintenance reminders, and a periodic vehicle report card. System 10 may integrate with shop management systems, allowing for expanded automated download of vehicle-specific service records and tracking of discount use. The information may be incorporated into the user's vehicle service history or profile.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A computer implemented method for determining compliance with vehicle recommendations, wherein the computer comprises a processor and a memory coupled to the processor and configured to store instructions executable by the processor to perform the method comprising:
generating a vehicle recommendation, wherein the vehicle recommendation comprises a recommended vehicle action;
transmitting the vehicle recommendation to at least one output device, wherein at least one output device communicates the vehicle recommendation to one or more users;
collecting vehicle telemetry data from a vehicle sensor device located in a vehicle, wherein the vehicle sensor device is coupled to one or more vehicle sensors; and
determining compliance data based on the vehicle recommendation and the vehicle telemetry data, wherein the compliance data indicates compliance with the recommended vehicle action.

2. The method of claim 1, wherein at least one output device is located in the same vehicle as the vehicle sensor device.

3. The method of claim 1, wherein the recommendation is generated using environmental data relating to the vehicle that the vehicle sensor device is located in.

4. The method of claim 1, wherein generating the vehicle recommendation further comprises:
gathering vehicle telemetry data from other vehicles; and
generating the vehicle recommendation based on the vehicle telemetry data gathered from other vehicles.

5. The method of claim 4, wherein generating the vehicle recommendation further comprises comparing the telemetry data from the other vehicles to one or more vehicle conditions to select the recommended vehicle action.

6. The method of claim 1, wherein generating the vehicle recommendation further comprises:
gathering vehicle telemetry data from the vehicle sensor device; and
generating the vehicle recommendation based on the vehicle telemetry data gathered from the vehicle sensor device.

7. The method of claim 1, further comprising:
storing a profile linked to the vehicle sensor device; and
recording a compliance metric in the profile, wherein the compliance metric is based on the compliance data.

8. The method of claim 7, further comprising recording a recommendation metric in the profile based on the vehicle recommendation.

9. The method of claim 7, wherein the compliance metric is for use in determining a service rate for providing one or more vehicle services.

10. The method of claim 9, further comprising determining the service rate, wherein the service rate is determined based on the compliance metric.

11. The method of claim 7, wherein the compliance metric is for use in determining a service level defining coverage of one or more vehicle services.

12. The method of claim 11, further comprising determining the service level, wherein the service level is determined based on the compliance metric.

13. The method of claim 1, wherein the vehicle telemetry data is selected from the group consisting of: a condition of the vehicle, a manner of operating the vehicle, and a condition of an environment for the vehicle.

14. The method of claim 4, wherein the vehicle telemetry data gathered from the other vehicles comprises a plurality of data sets, each data set associated with an identifier corresponding to a vehicle selected from the other vehicles that the vehicle telemetry data was gathered from, a timestamp, and a location.

15. The method of claim 1, wherein the vehicle telemetry data comprises vehicle diagnostic data, and wherein at least one vehicle sensor device is coupled to an onboard diagnostic system of the vehicle.

16. The method of claim 5, wherein the vehicle condition relates to one or more members selected from the group consisting of: a condition of a vehicle, manner of operating a vehicle, and a condition of an environment for a vehicle.

17. The method of claim 1, wherein the recommended vehicle action relates to one or more members selected from the group consisting of: a condition of a vehicle, manner of operating a vehicle, and a condition of an environment for a vehicle.

18. The method of claim 5, wherein the recommended vehicle action refers to a location defined by a geographical tag proximate to the vehicle.

19. The method of claim 4, wherein the vehicle telemetry data gathered from the other vehicles comprises a plurality of data sets, each data set associated with a timestamp and a location, and wherein generating the vehicle recommendations further comprises:
correlating the data sets based on the timestamps and the locations.

20. The method of claim 1, wherein the output device is operable to display the recommended vehicle action.

21. The method of claim 20, wherein the output device is located within the same vehicle as the vehicle sensor device.

22. The method of claim 21, wherein the output device and the vehicle sensor device form are integrated as part of the same device.

23. The method of claim 1, wherein the output device comprises an electronic sign observable by the vehicle.

24. The method of claim 1, wherein the output device is located in the same vehicle as the vehicle sensor device and generates audible output corresponding to the recommended vehicle action.

25. A computer implemented method for determining compliance with vehicle recommendations, wherein the computer comprises a processor and a memory coupled to the processor and configured to store instructions executable by the processor to perform the method comprising:
gathering vehicle telemetry data from a vehicle sensor device located in a vehicle, wherein the vehicle sensor device is coupled to one or more vehicle sensors;
generating a vehicle recommendation, wherein the vehicle recommendation comprises a recommended vehicle action;
transmitting a report to at least one output device, wherein the report comprises the vehicle recommendation;
collecting additional vehicle telemetry data from the vehicle sensor device located in the vehicle; and
determining compliance data based on the vehicle recommendation and the additional vehicle telemetry data, wherein the compliance data indicates compliance with the recommended vehicle action.

26. The method of claim 25, further comprising determining a service rate for providing one or more vehicle services, wherein the service rate is determined based on the compliance data.

27. The method of claim 25, further comprising determining a service level defining coverage of one or more vehicle services, wherein the service level is determined based on the compliance data.

28. The method of claim 1, wherein the vehicle telemetry data is selected from the group consisting of: a condition of the vehicle, a manner of operating the vehicle, and a condition of an environment for the vehicle.

29. A system for determining compliance with vehicle recommendations comprising a processor and a memory coupled to the processor and configured to store instructions executable by the processor to:
generate a vehicle recommendation, wherein the vehicle recommendation comprises a recommended vehicle action;
transmit the vehicle recommendation to at least one output device, wherein the at least one output device communicates the vehicle recommendation to one or more users;
collect vehicle telemetry data from a vehicle sensor device located in a vehicle, wherein the vehicle sensor device is coupled to one or more vehicle sensors; and
determine compliance data based on the vehicle recommendation and the vehicle telemetry data, wherein the compliance data indicates compliance with the recommended vehicle action.

30. A computer readable storage medium storing one or more sequences of instructions, which when executed by one or more processors, causes the one or more processors to perform a method for determining compliance with vehicle recommendations comprising:
generating a vehicle recommendation, wherein the vehicle recommendation comprises a recommended vehicle action;
transmitting the vehicle recommendation to at least one output device, wherein the at least one output device communicates the vehicle recommendation to one or more users;
collecting vehicle telemetry data from a vehicle sensor device located in a vehicle, wherein the vehicle sensor device is coupled to one or more vehicle sensors; and
determining compliance data based on the vehicle recommendation and the vehicle telemetry data, wherein the compliance data indicates compliance with the recommended vehicle action.
